(19) United States
(12) Patent Application Publication
(10) Pub. No.: US 2012/0192796 A1
(43) Pub. Date: Aug. 2, 2012

(54) Temperature-adjustable warming apparatus for a hummingbird feeder and food

(76) Inventors: Robert John Saunders, Portland, OR (US); Dolores Marie Wheeler, Portland, OR (US)

(21) Appl. No.: 12/931,281

(22) Filed: Jan. 28, 2011

(51) Int. Cl. A01K 39/04

(52) U.S. Cl. 119/73

(57) ABSTRACT

The apparatus disclosed and claimed herein comprises a weather cap, a heat source located within said weather cap, a bird feeder, and a suspension device for attaching said bird feeder to said weather cap in proximity to said heating element. The method disclosed and claimed herein comprises providing hummingbird food in a hummingbird feeder, providing a source of heat, transferring the heat to the hummingbird food in the hummingbird feeder such that the food will be kept liquid in an environment where said food would normally become solid, through heat conduction, heat radiation, heat convection or any combination of these.

### CROSS-REFERENCE TO RELATED APPLICATIONS

This application claims the benefit of U.S. Provisional Patent Application Ser. No. 61/336,774 filed 2010 Jan. 27, 2010 by the present inventors.

### BACKGROUND OF THE INVENTION

Hummingbirds are common throughout much of the United States of America, as are their human supporters, many of whom choose to provide them with food. This pastime helps the hummingbird population thrive and provides enjoyment for the observer. There are significant differences between a hummingbird feeder and feeders for other types of birds. Hummingbird feeders are designed to dispense a liquid as opposed to a solid, such as birdseed. They are suspended in the air from some height, preferably 1.5 meters or higher, to prevent easy access by ants, to prevent the hummingbird from becoming prey to ground based predators such as cats, and to make the feeder easily visible to the hummingbird. In addition, hummingbird feeders are used exclusively outdoors and are subject to, and are built to withstand, the ravages of nature's outdoor environment.

The design of a hummingbird feeder and its operation in a suspended position is heavily influenced by the fact that a hummingbird, unique among birds, can hover. The feeding method, often coupled with the lack of a resting surface, and the ability of the feeder to freely move and “swing” from a single suspended point and not be part of a rigid structure, are all specifically used together to assure that only a hummingbird may feed from it. The hummingbird feeder has many unique properties.

Hummingbird food is a sugar water solution, and the feeders are designed to allow the hummingbird to insert its beak into the feeder which leads to the sugar water solution.

This prevents sugar-feeding flying insects such as bees from accessing the food. A problem exists in that sugar water, usually in a 4 to 1 concentrations recommended for use in feeders, freezes at approximately −1.0 to −2.0 degrees Centigrade. In many climates the Fall, Winter, and Spring seasons bring temperatures well below the freezing point of the sugar water mixture, causing the bird food to become solid. Hummingbirds are unable to feed from this solid, and so they are unable to access the food in this inclement weather, which is the time they may need it the most.

No solution to this problem has been previously proposed, and all proposed embodiments are clearly and obviously insufficient for the purpose of providing even minimal warmth.

### SUMMARY OF THE INVENTION

The apparatus disclosed and claimed herein comprises a weather cap, a heat source located within said weather cap, a bird feeder, and a suspension device for attaching said bird feeder to said weather cap in proximity to said heating element. The method disclosed and claimed herein comprises providing hummingbird food in a hummingbird feeder, providing a source of heat, transferring the heat to the hummingbird food in the hummingbird feeder such that the food will be kept liquid in an environment where said food would normally become solid, through heat conduction, heat radiation, heat convection or any combination of these.

### BRIEF DESCRIPTION OF THE DRAWINGS

FIG. 1 shows a cross-section view of one embodiment of the entire warming apparatus;

FIG. 2 is a view of the warming apparatus in operation in one embodiment, suspended from a hanger on a post, with a hummingbird feeder suspended below it; and

FIG. 3 shows a cross-section view of one embodiment of the entire warming apparatus with a temperature-based power switch.

### DETAILED DESCRIPTION OF THE INVENTION

A safe and effective method of keeping the bird food liquid in freezing weather is provided; in addition, given the characteristics of the hummingbird feeder, the method of operation, and the environmental issues that the feeder is subject to, a heating unit specific to the unique design of hummingbird feeders is needed. For instance, such a heating unit must allow for the feeder's suspension and subsequent movement and not interfere with it or the bird's access to the feeder. It must be capable of being in sufficient proximity to the hummingbird feeder to maintain warmth of the food, and also be able to maintain that proximity while the feeder swings and turns as a result of the suspended environment. It cannot interfere with, and ideally should enhance, the function and operation of the feeder. Any added vertical displacement created by the use of the heating unit must be small enough to keep the hummingbird feeder from hanging too low. It must be capable of operating safely and continuously in adverse environmental conditions, and specifically be capable of routine operation under wet and freezing conditions. And of course it must provide a safe and effective method of maintaining the hummingbird food in a liquid state.

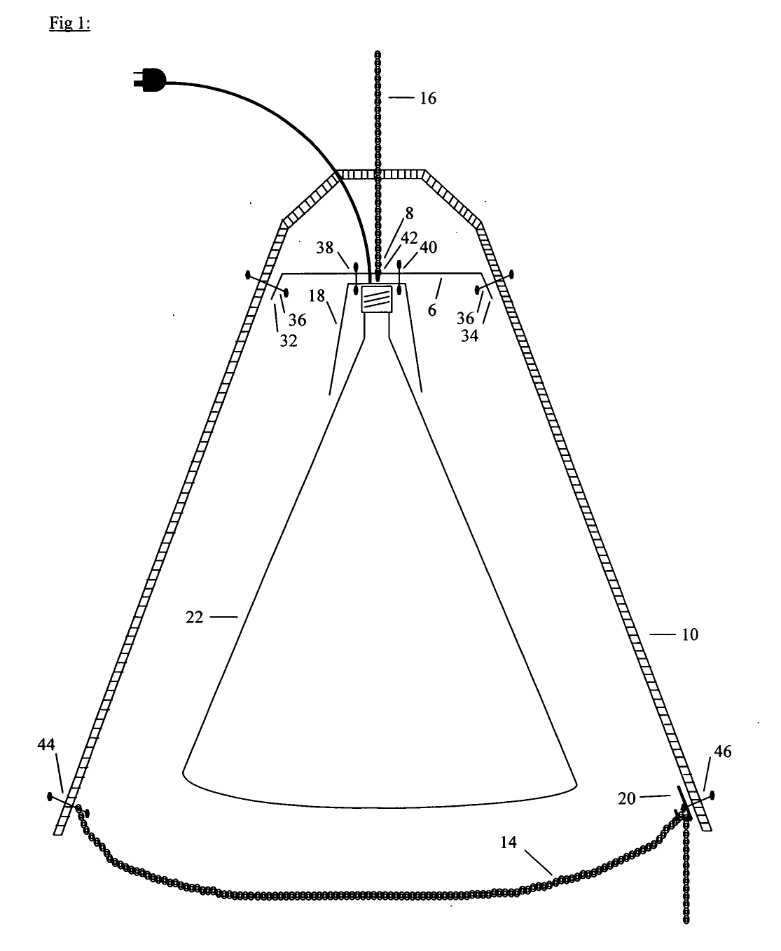

In accordance with one embodiment, a warming apparatus for a hummingbird feeder, providing a source of warmth, with the purpose of transferring sufficient heat energy such that the feeder food is kept above its freezing point. Referring to FIG. 1, and describing one embodiment, a warming apparatus 1 is provided. Mechanically, the central point of the apparatus 1 is the tie bar 6 which ties the components 10 and 18 together and provides a suspension point 8 for the entire warming apparatus 1. The source of warmth is partially surrounded by and attached to a weather cap 10. The tie bar 6 is of appropriate length to fit within the weather cap 10 at the top of the apparatus 1, of appropriate width and thickness to provide sufficient mechanical strength to support both the warming apparatus 1 and a hummingbird feeder 26 but yet not prevent the flow of air through the warming apparatus 1. In this embodiment, the tie bar 6 may be 10 cm in length, 2.5 cm in width, 0.6 cm thick, and may be composed of aluminum, but a number of different arrangements and materials could be used and maintain keeping with the spirit of the invention. The two ends 32 and 34 of the tie bar 6 are bent approximately 1.3 cm from each end 32 and 34 of the tie bar 6 at an angle matching the interior angle of the weather cap, and in the center of both bent portions a hole 36 is drilled such that mounting hardware can be used to affix the weather cap. Two additional holes 38 and 40 are drilled at appropriate points along the length of the tie bar to accept mounting hardware for the outdoor flood lamp fixture 18. Finally a hole 42 is drilled in approximately the center of the tie bar to accept mounting hardware for a suspending chain 16 from which the warming apparatus 1 is suspended. In one embodiment, the suspending chain is #200 brass twist chain, but any sufficiently strong cord, chain, wire, or other similar flexible length of suspending material will suffice. The outdoor lamp fixture is firmly mounted to the tie bar via the mounting hardware. One embodiment of the warming apparatus 1 uses a 90 Watt 110V PAR38 outdoor flood lamp for the source of warmth, but any sufficient source providing warmth is applicable. The fixture may consist of any commercially or non-commercially built, preferably grounded lamp fixture which may also incorporate a PAR38 screw lamp receptacle and preferably a weather-sealed power cord connection, although any fixture or heat source may be used. In one embodiment, a Sigma Electric Metal Spike-A-Lite model 14792GN is used, but any appropriate outdoor lamp fixture will maintain keeping with the spirit of the invention.

The weather cap performs a number of important functions: it protects the interior components of the warming apparatus from simple harm from everyday use; it protects the interior components from extreme weather; it provides a visual shield from the interior components, making the warming apparatus more pleasing to the eye; and it provides a base to which a hummingbird feeder suspending chain 14 is connected. It can be made of any appropriate shape and material which at a minimum fulfill these functions.

The weather cap 10 in one embodiment is made of six pieces of fire-resistant wood shingle material, each being approximately 23 cm in length, 10 cm wide across the base, and 5 cm wide at the top. The opposing long sides of each of the six pieces are cut at 30 degree angles such that the pieces fit tightly along the sides when assembled together, and are glued with a high-performance glue appropriate for use on the material of which the six pieces are constructed.

The entire apparatus hangs by a suspension point at the top. the source of warmth is suspended just above the hummingbird feeder, and the hummingbird feeder hangs below it. At the base, the weather cap incorporates an adjustable hanging point for a hummingbird feeder. Preferably, the hummingbird feeder allows the hummingbird to place it's beak through a small opening at the end of a long tube. The opening is small enough that surface tension of the liquid keeps the liquid from spilling out through the tube.

At the base of two opposing sides of the weather cap, a first hole 44 is located preferably approximately 1.3 cm from the bottom of the base, the first hole 44 to accept mounting hardware to provide a connection between one end of the hummingbird feeder suspending chain and the weather cap. The second hole 46 is to accept mounting hardware for the hook 20, on which an appropriate link of the hummingbird feeder suspending chain may be placed. The hook is of appropriate size and strength such that the interior of any arbitrary link of chain can slide onto it, such that the feeder suspending chain is held fast at that point. Securely held at two points, the feeder suspending chain forms an arc at the lowest point of the warming apparatus, creating an attachment point for a hummingbird feeder.

A flood lamp 22 of appropriate size and wattage to act as a source of warmth, sufficient to maintain the hummingbird feeder food liquid in the prevailing outdoor conditions is screwed into the receptacle of the outdoor flood lamp fixture. In one embodiment the food lamp is a Sylvania PAR38, 90-watt outdoor flood lamp. The source of warmth is in alternate embodiments any sufficient source of warmth providing heat radiation, heat convection, or heat conduction to the hummingbird feeder and food, such as (but not envisioned to be limited to) a ceramic heating element, light sources, resistive wire heating elements, or small gas heating units.

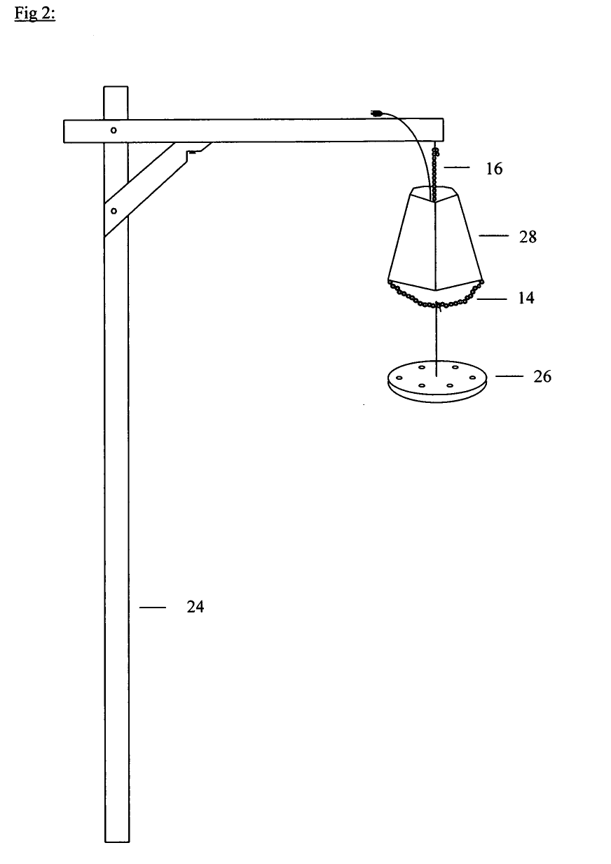

Referring to FIG. 2, in operation, the user suspends the warming apparatus 28 by the suspending chain 16, from a roof eve, pole 24, or a similarly appropriate position. A hummingbird feeder 26 filled with liquid food is then attached to the hummingbird feeder suspending chain 14, and the chain 14 is adjusted to a nominal length. The the warming apparatus is then attached to an source. In one embodiment, the outdoor flood lamp provides sufficient warmth to the feeder to prevent the liquid food from freezing, and has been tested to do so at temperatures down to below −9 degrees Centigrade. After a few hours of operation, the hummingbird feeder and warming apparatus will reach thermal equilibrium, and the temperature of the hummingbird feeder (and the food therein) can be adjusted by hooking a different link on the humming bird feeder suspending chain 14, thereby changing the distance between the hummingbird feeder 26 and the outdoor flood lamp. If the temperature range is insufficient, an outdoor flood lamp of appropriate wattage can be chosen and used instead.

The adjustable hanging point, implemented by a suspended chain in one embodiment, allows the attachment of any generic, commercially-available hummingbird feeder. The adjustable hanging point also allows the user to easily change the warmth the hummingbird feeder receives by simply increasing or decreasing the distance between the source of warmth and the feeder, by means of simply shortening or lengthening the chain. This is accomplished by hooking the chain one side of the weather cap at any point along its length. Wider ranges of temperature variation are achieved by using different-wattage sources of warmth.

While a specific method of warming a hummingbird feeder and the food therein is described, there are a very large number of methods of providing a source of warmth; as the invention is specifically warming the feeder and food to keep the food from freezing, all such methods providing radiant, conductive, or convective heat energy are envisioned in the application for patent, and the patent should not be limited to the specific example provided. In addition, the placement of the source of warmth is envisioned to be located either above, alongside, or underneath the hummingbird feeder, or at angles or some combination of these; each of these placements can be made to fulfill the function of the invention, and each placement has relative advantages and disadvantages.

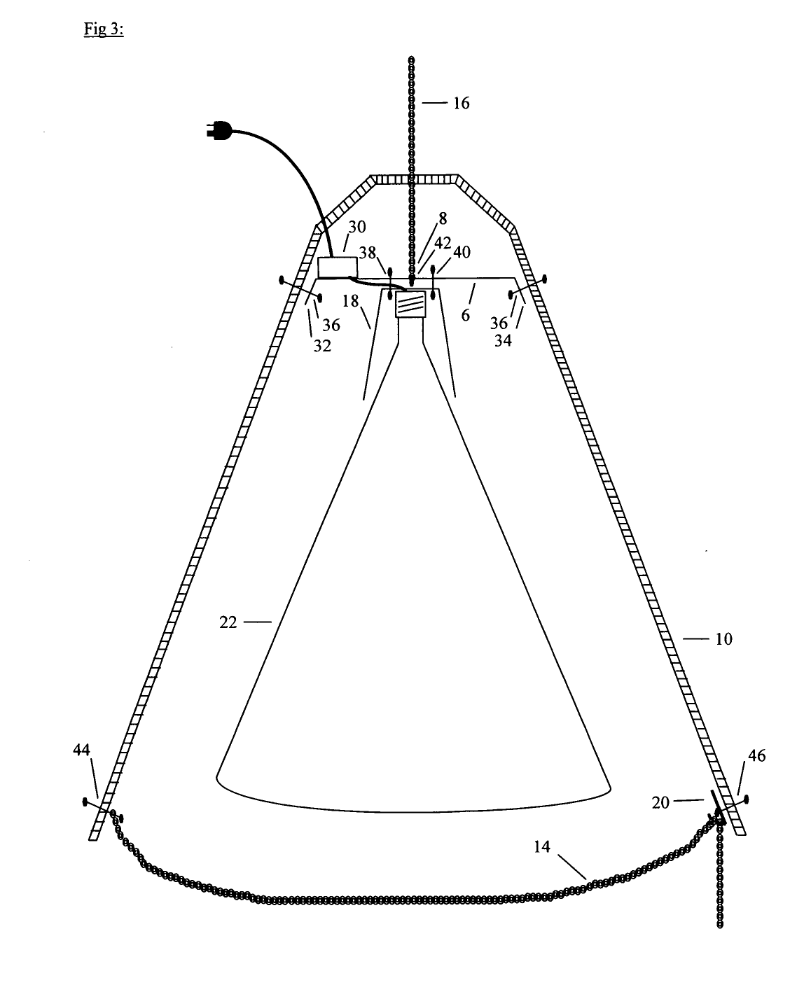

Referring now to FIG. 3, in an alternative embodiment, a temperature-controlled relay 30 or alternative temperature-controlled power cutoff device (Therm-O-Disk Model 36F or similar) is incorporated into the design, being placed in line with the power supply to the source of warmth such that power is only supplied to the source of warmth when the temperature falls below a predetermined point. Thus the warming apparatus uses less electrical power than an apparatus without the aforementioned cutoff device. While this embodiment will control power to any source of warmth powered by electrically, the same thermally controlled method is envisioned to be used for other sources of power, such as a thermally controlled gas valve for sources of warmth that use gas, or a thermally controlled liquid valve for sources of warmth that use a heat pipe.

In other alternative embodiment the source of warmth is placed in a position below, beside or around the hummingbird feeder as opposed to above it. While this provides for greater and more efficient convective and (if placed in contact with the hummingbird feeder or the liquid) conductive heat transfer from the source of warmth to the hummingbird feeder and the hummingbird food within, the source of warmth is exposed to greater potential damage from spillage of food, accidental handling damage, bird droppings, and weather, even if sufficient protection is provided.

The advantage of such a positioning is a lower requirement for power usage by being able to take greater advantage of heat convection (heat rises) and by being able to place the source of warmth nearer the location of the feeding point of the hummingbird feeder, which is universally at the bottom as the feeding point is gravity fed.

Accordingly, the advantage of using such an apparatus is the improved ability of the user to provide food to the hummingbird, providing a source of food when it is most needed. In addition, there is solid antidotal evidence that hummingbirds can become stuck to frozen hummingbird feeders in exactly the same manner that one becomes stuck to a frozen pole if one sticks his tongue out to touch it; in such instances their accustom source of food can become a death trap. Keeping the hummingbird food liquid becomes very important.

Accordingly, the reader will see the immense advantage of heating a hummingbird feeder to extend the ability to feed into environments where it would otherwise be impossible. Further, the use of the apparatus has additional advantages:
Use of the apparatus will frankly save the lives of many hummingbirds which would otherwise die for lack of food.
Heat from the apparatus will warm the immediate environment around the feeder as well as the feeder itself. This provides temporary relief from environmental stress on the hummingbird.
When using a light source as a source of warmth, light striking the hummingbird is highly reflected by the iridescent feathers of the hummingbird. This creates a striking and visually pleasing display.

Although the description above contains many specifics, these should not be construed as limiting the scope of the embodiments by merely providing illustrations of several embodiments. For example, the cap may have many shapes or be constructed of many materials; the source of warmth could consist of any sufficient source of radiant, convective, or conductive heat energy, or multiple combinations of these; each source of warmth could be powered by any sufficient supply of power; and the placement of the source or sources of warmth could be vary widely as long as the proximity allowed for sufficient heat transfer to the food within the hummingbird feeder to keep it liquid at the feed point.

A warming apparatus for the purpose of keeping hummingbird food in a hummingbird feeder in a liquid state in freezing temperatures outdoors, where food would otherwise become solid, through use of heat convection, heat conduction, heat radiation, or any combination of these. Adjustments are envisioned to allow the user to vary the amount of heat provided to the food. In one embodiment, a temperature-sensitive power switch is provided such that warmth is only provided when required to keep the food liquid, thus saving power.

Thus the scope of the embodiments should be determined by the appended claims and their legal equivalents, rather than by the examples given. Although the preferred embodiment has been described in detail, it should be understood that various changes, substitutions, equivalents and alterations can be made therein without departing from the spirit and scope of the invention as defined by the appended claims.

I claim:

1. A method comprising the steps of:
providing hummingbird food in a hummingbird feeder;
providing a source of heat;
transferring the heat to the hummingbird food in the hummingbird feeder such that the food will be kept liquid in an environment where said food would normally become solid, through heat conduction, heat radiation, heat convection or any combination of these.

2. The method of claim 1 wherein one or more sources of heat are placed in sufficient proximity to the hummingbird feeder containing liquid food, such that the food is kept liquid in temperatures where such food would normally become solid.

3. The method of claim 1 wherein a source of heat is comprised of one or more electrically powered lamps placed in sufficient proximity to or direct contact with the hummingbird feeder or the food within such that the food is kept liquid in temperatures where such food would normally become solid.

4. The method of claim 1 wherein a source of heat is comprised of one or more electrically resistive elements, placed in sufficient proximity to or directly in contact with the hummingbird feeder or the food within such that the food is kept liquid in temperatures where such food would normally become solid.

5. The method of claim 1 wherein one or more electrically powered sources of heat incorporate a temperature-controlled relay or alternative temperature-controlled power cutoff device, such that power is only supplied to the source of warmth when the temperature falls below a predetermined point, thus using less electrical power than an apparatus without the aforementioned relay.

6. An apparatus comprising:
a weather cap;
a heat source located within said weather cap;
a bird feeder; and
a suspension device for attaching said bird feeder to said weather cap in proximity to said heating element.

7. The apparatus of claim 6 wherein said bird feeder is a liquid containing bird feeder.

8. The apparatus of claim 6 wherein said bird feeder is a hummingbird feeder.

9. The apparatus of claim 6 wherein said hummingbird feeder contains a sugar water solution.

10. The apparatus of claim 6 wherein said heating element is a light bulb.

11. The apparatus of claim 6 wherein said heating element is resistive heat source.

12. The apparatus of claim 6 further comprising a tie bar to attach said heating element to said weather cap.

13. The apparatus of claim 6 wherein said heat source is close enough to said hummingbird feeder such that liquid food in said hummingbird feeder will be kept liquid in an environment where said food would normally become solid.

14. The apparatus of claim 6 wherein heat is transferred from said heat source to said food by heat conduction.

15. The apparatus of claim 6 wherein heat is transferred from said heat source to said food by heat radiation.

16. The apparatus of claim 6 wherein heat is transferred from said heat source to said food by heat convection.

17. The apparatus of claim 6 wherein heat is transferred from said heat source to said food by any combination of heat conduction, heat radiation or heat convection.

18. The apparatus of claim 6 and further comprising a controller for controlling said heat element.

19. The apparatus of claim 6 and further comprising one or more additional heat sources.

20. The apparatus of claim 6 wherein the hummingbird feeder comprises a number of small openings at the end of narrow tubes.
